(19) United States
(12) Patent Application Publication
(10) Pub. No.: US 2008/0145503 A1
(43) Pub. Date: Jun. 19, 2008

(54) Fried Nut Snack Chip

(76) Inventors: Carol McCall, McKenney, TX (US); Scott L. Sullivan, Frisco, TX (US); Richard Todd Smith, McKinney, TX (US)

Correspondence Address: Colin P. Cahoon;CARSTENS & CAHOON, LLP, P.O. Box 802334, Dallas, TX, 75380, US

(21) Appl. No.: 11/611,277

(22) Filed: Dec. 15, 2006

(51) Int. Cl. A21D 10/02; A23L 1/10; A23L 1/36

(52) U.S. Cl. 426/557; 426/549

(57) ABSTRACT

The present invention discloses formulations for fried nut-based snack chips that have a hearty, crunchy, blistered texture. Ingredient formula ranges and processing steps are disclosed that provide improved dough sheet integrity during processing, and improved flavor, texture, appearance and structural integrity of the fried snack chip. The dry ingredients are combined with water to make a dough, which is then sheeted and cut into pieces. The pieces are toasted and fried to produce nut-based snack chips.

### BACKGROUND OF THE INVENTION

1. Technical Field

The present invention relates to a method for making an improved fried snack food and, more particularly, to a method for making a sheeted, fried snack food having high contents of visible nut pieces, a hearty, crunchy, blistered, chip-like texture, a recognizable nut flavor and the nutritional benefits of nuts.

2. Description of Related Art

Snack items are an important consumer item for which there exists a great demand. Snacks can also play a large role in the diet of consumers. Peanuts and other types of nuts are a preferred snack item because they are nutritious due to their high protein content. Many nuts also have high fiber content, which has been attributed to reducing a person's risk of certain cancers, diabetes, digestive disorders, and heart diseases. Fiber may also help people control obesity, because insoluble fiber is not digested and passes through the digestive system virtually in tact, providing bulk but very few calories. Studies have also shown that people who consume nuts on a regular basis are less likely to suffer from coronary heart disease and can lower their LDL cholesterol levels, probably due to the fatty acid profile of nuts. Thus, the nutritious benefits of nut-based snack chips serve to distinguish them from other types of snack chips.

Although nuts can be consumed raw or cooked in their natural form, some people find that consuming whole nuts is undesirable due to their hard, chewy texture. Also, a large consumer demand exists for fried snacks in chip form with a hearty, crunchy, blistered texture like tortilla chips. It is desirable, therefore, to provide consumers with a fried nut-based snack chip with a hearty, crunchy, blistered, chip-like texture and a characteristic nut flavor that is produced from a sheeted dough.

There have been prior attempts to produce sheeted nut-based snack chips, but none have used an appropriate mixture of binder ingredients and nuts to produce a fried snack chip with visible pieces of nut particles and a hearty, crunchy, blistered finish that can maintain its structural integrity during transport, while also delivering the nutritional benefits of nuts. A need, therefore, exists for a nut-based snack chip with a crunchy, crispy, blistered texture with the nutritional value of nuts.

### SUMMARY OF THE INVENTION

The present invention provides a hearty, crunchy, blistered snack chip having a high content of visible nut pieces and improved structural integrity. The snack chip of the present invention preferably has at least about 30% nuts, and a final moisture content of about 1.5% by weight. In one aspect of the invention, chopped nut pieces are used as a healthy ingredient in fried snack chips. The nuts provide good taste, texture, appearance and nutritional benefits to the consumer. A defined nut particle size distribution is carefully chosen to promote adequate incorporation of the nuts with the binder ingredients, improve the ability to sheet and process the dough, and provide a finished product with desirable flavor, texture and appearance. In yet another aspect of the invention, a mixture of binder ingredients is included as an ingredient in order to hold together a large percentage of high fat particulates, such as nuts. The binder is a blend of starches and rice flour that, when used in the combinations disclosed herein, gives the dough a cohesiveness needed for sheeting and gives the final snack chips their hearty, crunchy, blistered texture. The types and quantities of these binder ingredients, the chosen nut particle sizes, along with proper toaster oven and fryer conditions deliver the desired texture, flavor and appearance. These as well as additional features and advantages of the present invention will become apparent in the following written description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flowchart indicating the processing steps for the present invention.

### DETAILED DESCRIPTION

The snack chips of the present invention are nut-based snacks that contain nut pieces and a binder material, and which take the final form of a fried snack chip having a hearty, crunchy, blistered texture. The nuts and other ingredients used in the snack chips of the present invention deliver improved texture, flavor and nutritional value to the consumer.

As used herein, the term “nut” is used in the culinary sense and includes any large, oily kernel found within a shell and used in food. Examples of nuts include, without limitation, peanut, almond, pistachio, cashew, Brazil nut, pecan, hazelnut and walnut. The following disclosure will focus on peanut and pistachio snack chips, but this is not intended to limit the scope of the invention, as other varieties of nuts fall within the teachings disclosed herein. The nuts used herein are preferably full-fat nuts, but the principles disclosed herein apply equally as well to other nuts, including nuts that are chopped or sliced, oil-roasted, dry-roasted, raw, blanched, unblanched, salted or unsalted, full-fat or partially defatted. The nuts that are preferably used in the present invention are any nuts which, in their raw form, contain 65% fat or less. All percentages used herein are by weight unless otherwise noted.

The snack chips of the present invention are preferably prepared with chopped nut pieces having a distinct particle size distribution profile. The particle size distribution profile for the chopped nut pieces affects the incorporation of the nut particles into the dough, the dough sheet integrity, and the final product appearance, flavor and texture. For example, if the chopped nut pieces are too large, the dough cannot be sheeted without experiencing holes in the sheet, which leads to a higher degree of oil absorption during frying and affects the final product texture and taste. If the chopped nut pieces are too small, the nut identity is lost and the finished product texture becomes more dense, less expanded, and less blistered. Consequently, using the proper chopped nut particle size distribution is important in obtaining the desired finished product in the present invention.

In one preferred embodiment, the peanuts used in the present invention are full fat, dry roasted, blanched peanuts. The ranges of preferred particle size distribution for the peanut pieces is summarized as follows: about 1% to about 12% are retained on a U.S. #6 mesh screen, about 28% to about 56% are retained on a U.S. #8 mesh screen, about 4% to about 30% are retained on a U.S. #10 mesh screen, about 6% to about 20% are retained on a U.S. #12 mesh screen, and about 14% to about 23% pass through a U.S. #12 mesh screen. Another preferred particle size distribution profile for the peanut pieces is summarized as follows: about 6% are retained on a U.S. #6 mesh screen, about 40% are retained on a U.S. #8 mesh screen, about 22% are retained on a U.S. #10 mesh screen, about 14% are retained on a U.S. #12 mesh screen, and about 18% pass through a U.S. #12 mesh screen.

All mesh screen sizes as used herein are based on the U.S. Sieve scale. The opening sizes for the U.S. Sieve scale are summarized in the following table:

TABLE I

Opening Size

| U.S. Sieve # | Millimeters | Inches |
|---|---|---|
| 4 | 4.76 | 0.187 |
| 5 | 4.00 | 0.157 |
| 6 | 3.36 | 0.132 |
| 7 | 2.83 | 0.111 |
| 8 | 2.38 | 0.0937 |
| 10 | 2.00 | 0.0787 |
| 12 | 1.68 | 0.0661 |
| 14 | 1.41 | 0.0555 |
| 16 | 1.19 | 0.0469 |

In another preferred embodiment, the pistachios used in the present invention are full fat, raw, diced pistachio nuts. The ranges of preferred particle size distribution for the chopped pistachio pieces is summarized as follows: about 5% to about 15% are retained on a U.S. #8 mesh screen, about 6% to about 18% are retained on a U.S. #10 mesh screen, about 10% to about 15% are retained on a U.S. #12 mesh screen, about 30% to about 50% are retained on a U.S. #16 mesh screen, and about 20% to about 40% pass through a U.S. #16 mesh screen. Another preferred particle size distribution profile is summarized as follows: about 9% are retained on a U.S. #8 mesh screen, about 12% are retained on a U.S. #10 mesh screen, about 13% are retained on a U.S. #12 mesh screen, about 37% are retained on a U.S. #16 mesh screen, and about 29% pass through a U.S. #16 mesh screen.

All of the foregoing particle size distributions have been found to produce a dough with sufficient sheet integrity to practice the present invention and produce a fried snack chip having a desired taste, appearance and hearty, crunchy, blistered texture. However, the particle size distributions listed above are not intended to limit the scope of the present invention in its broadest sense, as other particle size distributions are possible within the teachings disclosed herein.

To produce a nut-based snack chip dough with sufficient cohesiveness to be sheeted and cut into snack sized pieces, and a final snack chip with the desired hearty, crunchy, blistered texture with structural integrity, the nut pieces are mixed with a binder mixture and water to form a dough. The binder mixture is comprised of dry dough ingredients that help maintain dough cohesiveness and expansion during cooking, and contribute to the final product texture and enhanced flavor, among other things.

In one embodiment, rice flour is included in the binder mixture in the dough to maintain the dough cohesiveness, contribute to the final product texture and reduced breakage of the final product, thereby improving its structural integrity. Rice flour also helps provide a neutral tasting base that does not compete with the flavors of the incorporated nuts. Preferably, the rice flour is GL 1080, a partially gelatinized rice flour available from Sage V Foods, but can be any rice flour.

In another embodiment, waxy corn starch is included as an ingredient in the binder mixture. Waxy corn starch is a starch that is high in amylopectin. Amylopectin is a branch-chained polysaccharide. Most other corn starches contain significant amounts of amylose, which is a straight-chained polysaccharide. While normal corn starch typically has a ratio of about 25% amylose to about 75% amylopectin, waxy corn starch contains at least about 99% amylopectin. The starch used in the present invention is preferably waxy corn starch. The waxy starch used in the present invention preferably contains at least about 99% amylopectin starch and less than about 1% amylose starch. The waxy corn starch used in the present invention helps with final product expansion, dough cohesiveness, sheet smoothness and a resulting crispy texture. Waxy corn starch suitable for use in the present invention can be obtained from Tate & Lyle, PLC headquartered in London, United Kingdom, but can be any waxy starch.

In yet another embodiment, pregelatinized starch is included as an additional ingredient in the binder mixture. Pregelatinized starch has been processed to irrevocably alter the molecular structure of the native starch so that it easily forms pastes or gels when mixed with water. Pregelatinized starch contributes primarily to the dough cohesiveness and to a lesser extent to an expanded texture and structure in the finished product. The pregelatinzed starch used in the present invention is preferably Redisol 412 starch available from Tate & Lyle, PLC headquartered in London, U.K., but can be any similar, neutral pregelatinized starch.

In still another embodiment of the present invention, modified starch is included as a binder mixture ingredient to help the snack chip expand during cooking. Modified starches have been processed to alter their physical properties so they provide an expanded and crunchy product. Examples of chemical modifications to starches include, without limitation, cross-linking, substitution, and conversions. The modified starch used in this invention is preferably X-PAND'R Starch available from AE Staley Manufacturing Company, headquartered in London, U.K., but can be any similar modified starch.

In another preferred embodiment, native tapioca starch is used as an ingredient in the binder mixture. Tapioca starch is produced from treated and dried cassava root. It is relatively inexpensive, neutral in flavor and contributes to the dough cohesiveness and an expanded texture and structure in the finished product. The tapioca starch used in the present invention is preferably native tapioca starch available from Avebe Food, but can be any similar neutrally flavored, native starch.

Other ingredients that can optionally be included in the snack chips of the present invention include sugar or salt (for improved flavor), and lecithin powder or mono- or di-glycerides (as an emulsifier to reduce dough stickiness during processing). Also, defatted peanut flour or protein isolates from soy, wheat or whey sources may be included to achieve a good source of protein. Still more ingredients can be included within the scope of the present invention to enhance the taste, appearance, nutritional value or structure of the snack chip.

In one preferred embodiment of the nut-based fried snack chips of the present invention, water is mixed with the nut particles, binder mixture and other dry ingredients to make a nut-based dough. The resultant dough comprises about 20% to about 30% nut particles, about 10% to about 16% rice flour, less than about 4% waxy starch, about 4% to about 8% pregelatinized starch, about 4% to about 8% modified starch, about 13% to about 21% native starch, and about 25% to about 35% added water. In another preferred embodiment, the resultant dough comprises about 23% to about 27% nut particles, about 12% to about 14% rice flour, less than about 3% waxy starch, about 5% to about 7% pregelatinized starch, about 5% to about 7% modified starch, about 15% to about 19% native starch, and about 27% to about 33% added water.

In still another preferred embodiment, the nut particles comprise full fat, dry roasted, blanched pieces of peanuts, preferably having a particle a size distribution profile comprising about 1% to about 12% retained on a U.S. #6 mesh screen, about 28% to about 56% retained on a U.S. #8 mesh screen, about 4% to about 30% retained on a U.S. #10 mesh screen, about 6% to about 20% retained on a U.S. #12 mesh screen, and about 14% to about 23% passing through a U.S. #12 mesh screen. According to another preferred embodiment, the peanut pieces have a size distribution profile comprising about 6% retained on a U.S. #6 mesh screen, about 40% retained on a U.S. #8 mesh screen, about 22% retained on a U.S. #10 mesh screen, about 14% retained on a U.S. #12 mesh screen, and about 18% passing through a U.S. #12 mesh screen.

In another preferred embodiment, the nut particles comprise full fat, raw pieces of chopped pistachio nuts, preferably having a particle distribution comprising about 5% to about 15% retained on a U.S. #8 mesh screen, about 6% to about 18% retained on a U.S. #10 mesh screen, about 10% to about 15% retained on a U.S. #12 mesh screen, about 30% to about 50% retained on a U.S. #16 mesh screen, and about 20% to about 40% passing through a U.S. #16 mesh screen. In yet another preferred embodiment, the pieces of chopped pistachio nuts have a particle size distribution comprising about 9% retained on a U.S. #8 mesh screen, about 12% retained on a U.S. #10 mesh screen, about 13% retained on a U.S. #12 mesh screen, about 37% retained on a U.S. #16 mesh screen, and about 29% passing through a U.S. #16 mesh screen.

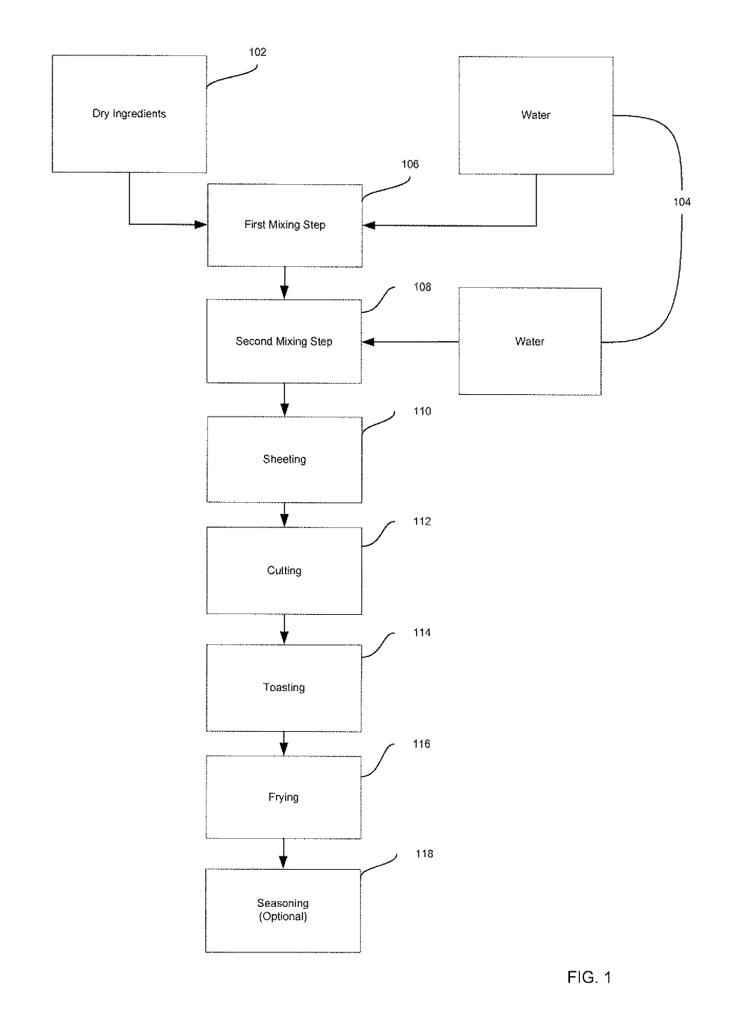

Referring to FIG. 1, a flowchart indicating the general processing steps for producing the nut-based snack chips of the present invention is illustrated. In the first processing step, the dry ingredients 102 are mixed with water 104 in a continuous, batch or other mixer to produce a dough. The mixing preferably occurs at temperatures between about 45° F. to about 80° F., and the dough exits the mixer between about 55° F. and about 85° F. Proper dough hydration is important in developing a favorable chip texture. Optimal nut inclusion occurs when the dough is not overworked and is initially starved for water, and ice water (comprising water mixed with ice) has been found to be preferable over water at ambient temperature. Preferably, two mixing steps are used. A first mixing step 106 wherein all of the dry ingredients 102 are mixed with between about 75% and 90% of the total water 104 added to the dough sufficiently starves the dough of water and helps fully include the nut particles in the dough. The dough then undergoes a second mixing step 108 wherein the remaining water 104 is added to fully hydrate the dough.

The dough is then sheeted 110, whereby the dough is compressed between at least one pair of counter rotating sheeter/cutter rollers that are located closely together, thereby providing a pinch point through which the dough is formed into sheets. The sheet of dough is preferably between about 1 millimeter and about 1.4 millimeters thick, and more preferably about 1.2 millimeters thick after the sheeting step. The targeted thickness can be accomplished by passing the dough through one set of rollers or several successive stages of rollers, with each successive stage having the rollers located progressively closer together.

The sheeted dough is then cut into a plurality of pieces 112, preferably using a rotary cutting unit. The pieces of dough are then toasted 114 in a toaster oven to achieve optimal product texture and blistering, and to further develop the nut flavor through roasting. The partially cooked pieces exit the toaster oven with a moisture content between about 20% and 29%, which is important in order to reduce oil pick-up during frying. The partially dehydrated chips are then fried 116 in hot oil bath to complete the dehydration of the product, further contribute to the finished product texture and to further develop the nut flavor through additional roasting. The oil used in the present invention is preferably a neutrally-flavored sunflower oil, but can be any oil with desirable flavor characteristics. The maximum temperature of the hot oil bath varies based on the sugar content of the nuts used. For lower sugar nuts such as almonds, hazelnuts or peanuts, the oil temperature can be as high as 385° F. without the snack chips developing any undesirable browning, scorching or bitter flavors. Nuts having a higher sugar content, such as cashews and pistachios must be fried at a lower oil temperature, with the maximum oil temperature being about 365° F. At any oil temperature, the chips are fried 116 to a final moisture content between about 1.5% and about 2.5%. The snack chips can then optionally be seasoned 118 in a tumbler.

The resultant nut-based snack chip in one preferred embodiment comprises about 31% to about 37% nut particles, about 15% to about 21% rice flour, about 1% to about 5% waxy starch, about 6% to about 11% pregelatinized starch, about 5% to about 11% modified starch, about 20% to about 27% native starch and less than about 2% water. The resultant nut-based snack chip in another preferred embodiment comprises 33% to about 35% nut particles, about 16% to about 20% rice flour, about 2% to about 4% waxy starch, about 7% to about 10% pregelatinized starch, about 6% to about 10% modified starch, about 22% to about 25% native starch and less than about 2% water.

### EXAMPLE

The table below illustrates the ingredients and their relative amounts that were used to make a peanut- or pistachio-based fried snack chip according to the present invention:

TABLE III

| | Wt. % Dry | Wt. % | Wt. % Final |
|---|---|---|---|
| Ingredient | Ingredients | Dough | Product |
| Nut Pieces | 34.64% | 24.32% | 34.12% |
| Rice Flour | 18.08% | 12.70% | 17.81% |
| Waxy Starch | 3.00% | 2.11% | 2.96% |
| Pregelatinized Starch | 8.81% | 6.18% | 8.68% |
| Modified Starch | 8.10% | 5.68% | 7.98% |
| Sugar | 3.07% | 2.14% | 3.02% |
| Tapioca Starch | 24.00% | 16.84% | 23.64% |
| Emulsifier | 0.30% | 0.21% | 0.30% |
| Water | — | 29.82% | 1.50% |

For the peanut chips of this example, the peanut particle size distribution was as follows: 5.75% was retained on a U.S. #6 mesh screen, 55.64% was retained on a U.S. #8 mesh screen, 4.33% was retained on a U.S. #10 mesh screen, 18.13% was retained on a U.S. #12 mesh screen, and 16.16% passed through a U.S. #12 mesh screen. For the pistachio nut chips of this example, the pistachio nut particle size distribution was as follows: 9% was retained on a U.S. #8 mesh screen, 12% was retained on a U.S. #10 mesh screen, 13% was retained on a U.S. #12 mesh screen, 37% was retained on a U.S. #16 mesh screen, and 29% passed through a U.S. #16 mesh screen.

For either the peanut chips or the pistachio nut chips, the nut pieces and other dry ingredients were combined in a batch mixer and mixed on low speed for approximately 2 minutes. The dough was then hydrated by mixing the dry ingredients with a mixture of water and ice in two mixing steps. In the first mixing step, approximately 80% of the total added water was added to the dry mixture and the dough was mixed on medium speed for about 1 minute. The bottom of the bowl was scraped to ensure optimal nut piece inclusion. In the second mixing step, the remaining 20% of the total added water was combined with the dough in the mixer and mixed on medium speed for an additional 30 seconds. The total amount of water added to the dough after both mixing steps were complete comprised about 30% of the total weight of the dough.

The dough was then sheeted using a 1 stage differential sheeter to produce a sheet of dough about 1.2 millimeters thick. The sheet of dough then passed through a rotary cutting unit that produced snack sized pieces of dough, each piece having an upper surface area between about 2 square inches and about 5 square inches. The pieces were then toasted in a triple-pass toaster oven at an oven temperature between about 620° F. and 625° F., with a total dwell time of about 14 seconds. The toasted pieces had a moisture content exiting the toasting oven between about 27% and about 29%. The toasted pieces were then fried in sunflower oil to a final moisture content between about 1.5% and about 2.5%. The peanut chips were fried at an oil temperature of about 385° F. for about 45 seconds. The pistachio nut chips were fried at an oil temperature of about 365° F. for about 50 seconds.

While the above example discloses some batch operations, it should be understood that the present invention can also comprise a continuous process throughout each unit step, or a mixture of continuous and batch operations.

The nut-based snack chips described in the above examples exhibit a hearty, crunchy, blistered, chip-like texture and structural integrity that allows them to survive shipment with minimal breakage. In addition, the snack chips disclosed herein have the added nutritional benefit of being made with nuts. In sum, the result is a fried nut-based snack chip having a hearty, crunchy, blistered texture, characteristic nut flavor, visible pieces of nuts, and improved structural integrity,

What is claimed is:

1. A nut-based dough comprising by weight:
about 20% to about 30% nut particles;
about 10% to about 16% rice flour;
less than about 4% waxy starch;
about 4% to about 8% pregelatinized starch;
about 4% to about 8% modified starch;
about 13% to about 21% native starch; and
about 25% to about 35% added water.

2. The dough of claim 1 wherein said nut particles comprise pieces of peanut.

3. The dough of claim 2 wherein said pieces of peanut have a particle size distribution as follows:
about 1% to about 12% are retained on a U.S. #6 mesh screen;
about 28% to about 56% are retained on a U.S. #8 mesh screen;
about 4% to about 30% are retained on a U.S. #10 mesh screen;
about 6% to about 20% are retained on a U.S. #12 mesh screen; and
about 14% to about 23% pass through a U.S. #12 mesh screen.

4. The dough of claim 2 wherein said pieces of peanut have a particle size distribution as follows.
about 6% are retained on a U.S. #6 mesh screen;
about 40% are retained on a U.S. #8 mesh screen;
about 22% are retained on a U.S. #10 mesh screen;
about 14% are retained on a U.S. #12 mesh screen; and
about 18% pass through a U.S. #12 mesh screen.

5. The dough of claim 2 wherein said pieces of peanut comprise pieces of full fat, dry roasted, blanched peanuts.

6. The dough of claim 1 wherein said nut particles comprise pieces of pistachio nut.

7. The dough of claim 6 wherein said pieces of pistachio nut have a particle size distribution as follows:
about 5% to about 15% are retained on a U.S. #8 mesh screen;
about 6% to about 18% are retained on a U.S. #10 mesh screen;
about 10% to about 15% are retained on a U.S. #12 mesh screen;
about 30% to about 50% are retained on a U.S. #16 mesh screen; and
about 20% to about 40% pass through a U.S. #16 mesh screen.

8. The dough of claim 6 wherein said pieces of pistachio nut have a particle size distribution as follows:
about 9% are retained on a U.S. #8 mesh screen;
about 12% are retained on a U.S. #10 mesh screen;
about 13% are retained on a U.S. #12 mesh screen;
about 37% are retained on a U.S. #16 mesh screen; and
about 29% pass through a U.S. #16 mesh screen.

9. The dough of claim 6 wherein said pieces of pistachio nut comprise pieces of full fat, raw pistachio nuts.

10. The dough of claim 1 wherein said nut particles comprise pieces of almond.

11. The dough of claim 10 wherein said pieces of almond comprise pieces of full fat, natural, raw almonds.

12. The dough of claim 1 wherein said nut particles comprise pieces of cashew.

13. The dough of claim 1 wherein said nut particles comprise pieces of hazelnut.

14. The dough of claim 1 wherein said native starch comprises a tapioca starch.

15. A fried nut-based snack chip comprising, by weight:
about 31% to about 37% nut particles;
about 15% to about 21% rice flour;
about 1% to about 5% waxy starch;
about 6% to about 11% pregelatinized starch;
about 5% to about 11% modified starch;
about 20% to about 27% native starch; and
less than about 2% water.

16. The snack chip of claim 15 wherein said nut particles comprise pieces of peanut.

17. The snack chip of claim 16 wherein said pieces of peanut have a particle size distribution as follows:
about 1% to about 12% are retained on a U.S. #6 mesh screen;
about 28% to about 56% are retained on a U.S. #8 mesh screen;
about 4% to about 30% are retained on a U.S. #10 mesh screen;
about 6% to about 20% are retained on a U.S. #12 mesh screen; and
about 14% to about 23% pass through a U.S. #12 mesh screen.

18. The snack chip of claim 16 wherein said pieces of peanut have a particle size distribution as follows:
about 6% are retained on a U.S. #6 mesh screen;
about 40% are retained on a U.S. #8 mesh screen;
about 22% are retained on a U.S. #10 mesh screen;
about 14% are retained on a U.S. #12 mesh screen; and
about 18% pass through a U.S. #12 mesh screen.

19. The snack chip of claim 16 wherein said pieces of peanut comprise pieces of full fat, dry roasted, blanched peanuts.

20. The snack chip of claim 15 wherein said nut particles comprise pieces of pistachio nut.

21. The snack chip of claim 20 wherein said pieces of pistachio nut have a particle size distribution as follows:
about 5% to about 15% are retained on a U.S. #8 mesh screen;
about 6% to about 18% are retained on a U.S. #10 mesh screen;
about 10% to about 15% are retained on a U.S. #12 mesh screen;
about 30% to about 50% are retained on a U.S. #16 mesh screen; and
about 20% to about 40% pass through a U.S. #16 mesh screen.

22. The snack chip of claim 20 wherein said pieces of pistachio nut have a particle size distribution as follows:
about 9% are retained on a U.S. #8 mesh screen;
about 12% are retained on a U.S. #10 mesh screen;
about 13% are retained on a U.S. #12 mesh screen;
about 37% are retained on a U.S. #16 mesh screen; and
about 29% pass through a U.S. #16 mesh screen.

23. The snack chip of claim 20 wherein said pieces of pistachio nut comprise pieces of full fat, raw pistachio nuts.

24. The snack chip of claim 15 wherein said nut particles comprise pieces of almond.

25. The snack chip of claim 24 wherein said pieces of almond comprise pieces of full fat, natural, raw almonds.

26. The snack chip of claim 15 wherein said nut particles comprise pieces of cashew.

27. The snack chip of claim 15 wherein said nut particles comprise pieces of hazelnut.

28. The snack chip of claim 15 wherein said native starch comprises a tapioca starch.

29. A method for making a nut-based snack chip, said method comprising:
making a dough by combining dry ingredients with added water, said dough comprising by weight:
about 20% to about 30% nut particles;
about 10% to about 16% rice flour;
less than about 4% waxy starch;
about 4% to about 8% pregelatinized starch;
about 4% to about 8% modified starch;
about 13% to about 21% native starch; and
about 25% to about 35% said added water;
forming said dough into a sheet;
cutting said sheet into a plurality of pieces;
toasting said pieces to produce toasted pieces; and
frying each said toasted piece to make a fried snack chip having moisture content between about 1.5% to about 2.5% by weight.

30. The method of claim 29 wherein said nut particles comprise pieces of peanut.

31. The method of claim 30 wherein said pieces of peanut have a particle size distribution as follows:
about 1% to about 12% are retained on a U.S. #6 mesh screen;
about 28% to about 56% are retained on a U.S. #8 mesh screen;
about 4% to about 30% are retained on a U.S. #10 mesh screen;
about 6% to about 20% are retained on a U.S. #12 mesh screen; and
about 14% to about 23% pass through a U.S. #12 mesh screen.

32. The method of claim 30 wherein said pieces of peanut have a particle size distribution as follows:
about 6% are retained on a U.S. #6 mesh screen;
about 40% are retained on a U.S. #8 mesh screen;
about 22% are retained on a U.S. #10 mesh screen;
about 14% are retained on a U.S. #12 mesh screen; and
about 18% pass through a U.S. #12 mesh screen.

33. The method of claim 30 wherein said pieces of peanut comprise pieces of full fat, dry roasted, blanched peanuts.

34. The method of claim 29 wherein said nut particles comprise pieces of pistachio nut.

35. The method of claim 34 wherein said pieces of pistachio nut have a particle size distribution as follows:
about 5% to about 15% are retained on a U.S. #8 mesh screen;
about 6% to about 18% are retained on a U.S. #10 mesh screen;
about 10% to about 15% are retained on a U.S. #12 mesh screen;
about 30% to about 50% are retained on a U.S. #16 mesh screen; and
about 20% to about 40% pass through a U.S. #16 mesh screen.

36. The method of claim 34 wherein said pieces of pistachio nut have a particle size distribution as follows:
about 9% are retained on a U.S. #8 mesh screen;
about 12% are retained on a U.S. #10 mesh screen;
about 13% are retained on a U.S. #12 mesh screen;
about 37% are retained on a U.S. #16 mesh screen; and
about 29% pass through a U.S. #16 mesh screen.

37. The method of claim 34 wherein said pieces of pistachio nut comprise pieces of full fat, raw, unsalted pistachio nuts.

38. The method of claim 29 wherein said nut particles comprise pieces of almond.

39. The method of claim 38 wherein said pieces of almond comprise pieces of full fat, natural, raw almonds.

40. The method of claim 29 wherein said nut particles comprise pieces of cashew.

41. The method of claim 29 wherein said nut particles comprise pieces of hazelnut.

42. The method of claim 29 wherein said native starch comprises a tapioca starch.

43. The method of claim 29 wherein said making step comprises:
a first mixing step wherein said dry ingredients are mixed with between about 75% and about 90% of said added water in said dough; and
a second mixing step wherein the about 10% to about 25% of said added water remaining from said first mixing step is mixed with said dry ingredients to produce said dough.

44. The method of claim 29 wherein said added water comprises liquid water mixed with ice.

45. The method of claim 29 wherein said toasting comprises:
cooking said pieces in a toasting oven at an oven temperature between about 620° F. and 625° F. to produce said toasted pieces, wherein each said toasted piece exits said toasting oven having a total moisture content between about 20% and about 29% by weight.

46. The method of claim 30 wherein said frying comprises:
frying each said toasted piece at an oil temperature no greater than 385° F. to produce said fried snack chip.

47. The method of claim 34 wherein said frying comprises:
frying each said toasted piece at an oil temperature no greater than 365° F. to produce said fried snack chip.

48. The method of claim 38 wherein said frying comprises:
frying each said toasted piece at an oil temperature no greater than 385° F. to produce said fried snack chip.

49. The method of claim 40 wherein said frying comprises:
frying each said toasted piece at an oil temperature no greater than 365° F. to produce said fried snack chip.

50. The method of claim 41 wherein said frying comprises:
frying each said toasted piece at an oil temperature no greater than 385° F. to produce said fried snack chip.

51. A snack chip produced by the method of claim 29.
